(19) United States
(12) Patent Application Publication
(10) Pub. No.: US 2006/0117886 A1
(43) Pub. Date: Jun. 8, 2006

(54) Geared transmission apparatus

(76) Inventors: Kousaku Ohno, Tsuchiura (JP); Kensuke Shoji, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/105,433

(22) Filed: Apr. 14, 2005

(30) Foreign Application Priority Data
Oct. 22, 2004 (JP) 2004-307565

(51) Int. Cl. F16H 1/14

(52) U.S. Cl. 74/423

(57) ABSTRACT

In a parallel shaft-type of conical-geared transmission apparatus, a conical pinion is fitted to a first rotation shaft, and a second rotation shaft is arranged in parallel to this first rotation shaft. A conical wheel meshing with the conical pinion is fitted to the second rotation shaft. The pinion and the wheel are substantially equal in cone angle. A supporting device supports the first rotation shaft to be movable in the axial direction. A pressing device applies thrust in the axial direction of the first rotation shaft. A load bearing body to bear the thrust applied by the pressing device and to allow the first rotation shaft to be displaced in the radial direction is provided at an end of the first rotation shaft.

### CROSS REFERENCE TO RELATED APPLICATION

The present application claims priority from Japanese application JP-A-2004-307565 filed on Oct. 22, 2004, the content of which is hereby incorporated by reference into this application.

### BACKGROUND OF THE INVENTION

The present invention relates to a geared transmission apparatus and more particularly to a geared transmission apparatus suitable for use in an actuator. An example of conventional geared transmission apparatus using a pair of conical gears is described in JP-A-6-257660. In the geared transmission apparatus described in this patent publication, the pitch surface of at least one of the gears is cylindrical, and the tooth curve is inclined by the cone angle relative to the axis of rotation, and the module of teeth does not vary along this tooth curve. The addendum modification coefficient of the geared transmission apparatus and the external dimension of the gears vary linearly. Further, there is provided a pressing mechanism to shift at least one of the gears in the axial direction. The geared transmission apparatus is thereby enabled to remove or adjust backlash while keeping the characteristics of conical gears.

The cone angle of conical gears is generally small, often only a few degrees. The reason is that the addendum modification coefficient of conical gears is greater at one-side ends of the teeth and smaller at the other-side ends as shown in FIG. 3. In other words, in a pinion having a smaller number of teeth, the tips are acute in the end part with a greater addendum modification coefficient, and an undercut may occur at the tooth roots in the end part with a smaller addendum modification coefficient. This trouble occurs where the cone angle or the tooth width is greater, or the number of teeth is smaller.

When a thrust is applied in the axial direction of the conical gears, a far greater reaction force than this thrust arises on the tooth surface. The smaller the cone angle, the greater this reaction force. Therefore, in the above-described structure wherein one of the pair of the conical gears whose cone angle is small is pressed in the axial direction, the reaction force occurring on the tooth surface becomes extremely large. As a result, the service lives of the gears and bearings are shortened, and the noise and vibration of the geared transmission apparatus increase.

### BRIEF SUMMARY OF THE INVENTION

An object of the present invention, attempted in view of the shortcomings noted above, is to facilitate adjustment of and reduce backlash in geared transmission apparatuses using conical gears. The invention is also intended to extend the useful lives of gears and bearings in geared transmission apparatuses.

In order to achieve the object stated above, according to the invention, there is provided a geared transmission apparatus having a conical pinion disposed on a first rotation shaft and a conical wheel fitted to a second rotation shaft substantially parallel to this first rotation shaft and meshing with the conical pinion, wherein the pinion and the wheel are formed to have substantially equal cone angles, and the geared transmission apparatus is further provided with supporting means for supporting the first rotation shaft to be movable in the axial direction, pressing means for applying a thrust to this first rotation shaft in the axial direction, and a load bearing body, provided at an end of the first rotation shaft, for bearing the thrust applied by the pressing means and allowing the first rotation shaft to be displaced in the radial direction.

It is preferable for the geared transmission apparatus to be further provided with means for making controllable the position of the load bearing body in the axial direction, and for the thrust applied by the pressing means to be partly guided to the tooth surfaces of the pinion and the wheel. Also, the load bearing body may be arranged in a position in which it comes into contact with the first rotation shaft, the hardness of this load bearing body may be lower than that of the first rotation shaft, and the region in which the first rotation shaft comes into contact with the load bearing body may be formed in a convex spherical shape. Further, the supporting means may be rolling bearings, this load bearing body may be kept in contact with the outer rings of these rolling bearings, and it is preferable to further provide a first bearing housing for holding the supporting means, another supporting means for supporting the second rotation shaft, and a second bearing housing for holding this latter supporting means, and to keep the first bearing housing and the second bearing housing in contact with each other via an intervening elastic member. Also, it is preferable for the spring constant of the first rotation shaft in the bending direction to be smaller than the spring constant of the supporting means in the radial direction, and for Young's modulus of the elastic member to be smaller than that of the first rotation shaft.

Other objects, features and advantages of the invention will become apparent from the following description of the embodiments of the invention taken in conjunction with the accompanying drawings.

### DETAILED DESCRIPTION OF THE SEVERAL VIEWS OF THE DRAWINGS

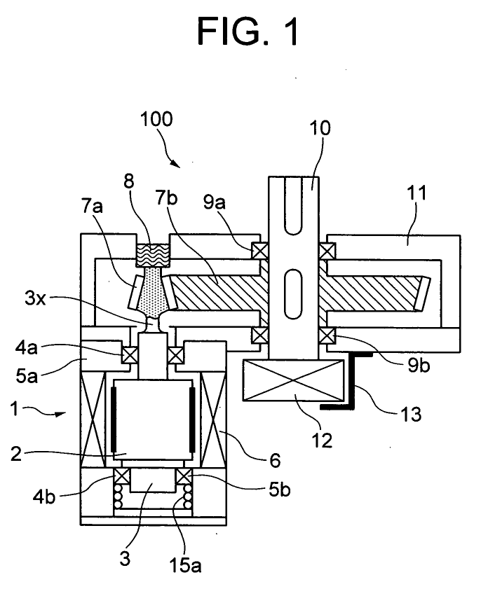

FIG. 1 shows vertical section of a geared transmission apparatus, which is a preferred embodiment of the invention;

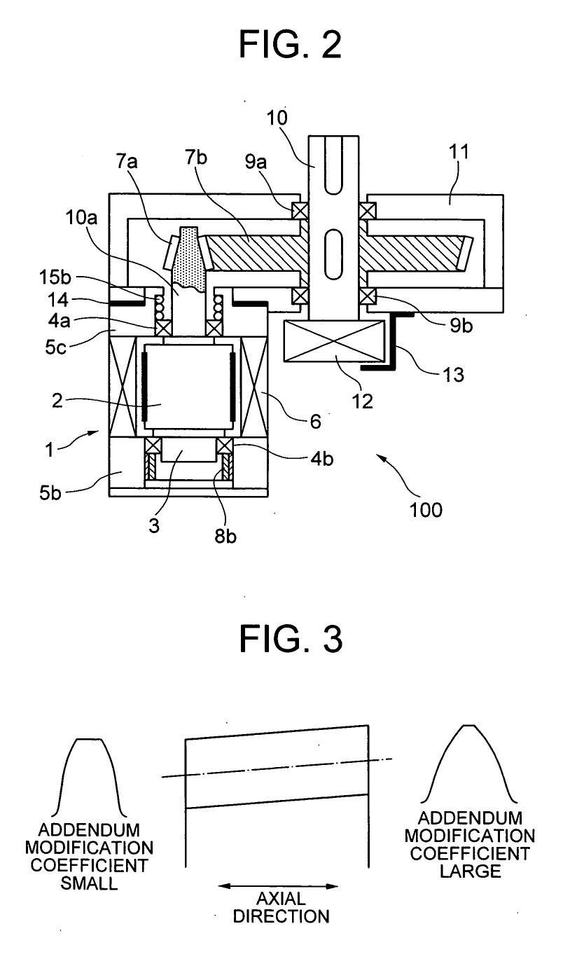

FIG. 2 shows vertical section of another geared transmission apparatus, which is another preferred embodiment of the invention;

FIG. 3 illustrates the tooth shape of a commonly known conical gear; and

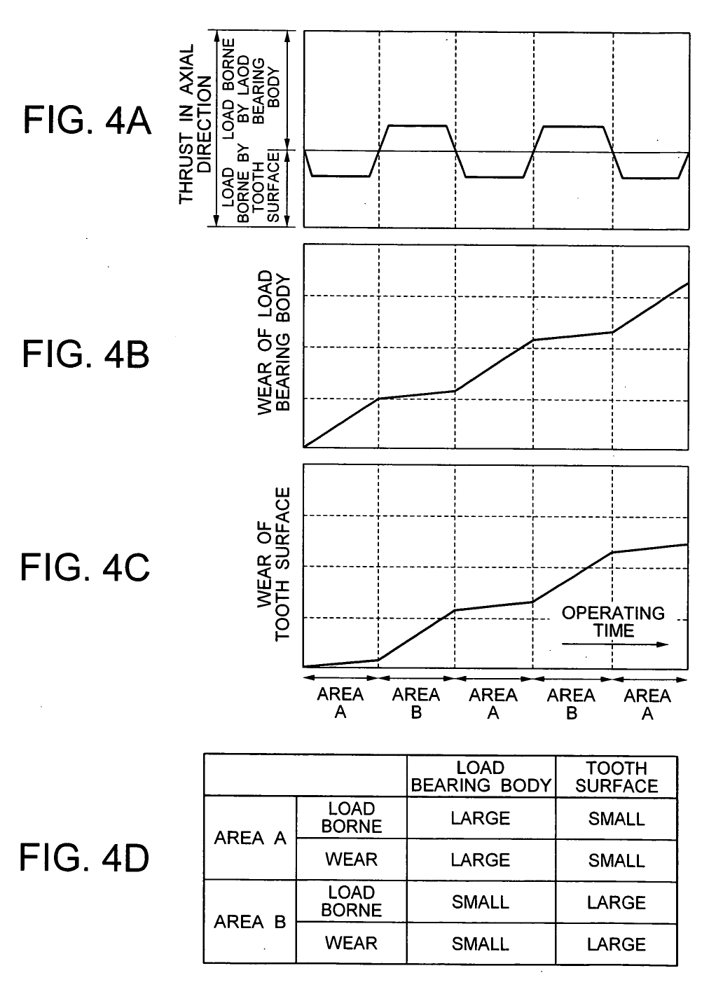

FIGS. 4A to 4D illustrate the wear characteristics of the gear tooth surface and of a load bearing body.

### DETAILED DESCRIPTION OF THE INVENTION

A few geared transmission apparatuses, which are preferred embodiments according to the present invention, will be described below with reference to the accompanying drawings. FIG. 1 shows a vertical section of a geared transmission apparatus 100. What is illustrated in this drawing is a small geared transmission apparatus 100 for use in an actuator for driving a robot arm or the like.

At the center of a driving motor 1, there are a rotor core 2 and a pinion shaft 3 formed integrally with this rotor core 2 and long extending toward one end. A stator core 6 is arranged around the rotor core 2 at some spacing from this rotor core 2. Motor housings 5a and 5b are fitted to the two ends of the stator core 6 in the axial direction. On the inner circumferential sides of the motor housings 5a and 5b, there are held pinion bearings 4a and 4b which rotatably support the pinion shaft 3. The driving motor 1 is a motor for control use, such as a stepping motor for example.

A conical pinion 7a is formed on the long extended side of the pinion shaft 3. The pinion bearing 4a is arranged between this conical pinion 7a and the rotor core 2, and supports the pinion 7a in a cantilevering way. On the other hand, the pinion bearing 4b is held by the motor housing 5b toward the other end than the pinion. Both of the pinion bearings 4a and 4b are rolling bearings, such as deep groove ball bearings.

To press the outer ring of the pinion bearing 4b provided on the other side than the pinion, a compression spring 15a is held on the inner circumferential side of the motor housing 5b. A load bearing body 8 which bears part of the thrust generated by the compression spring 15a is arranged at the end of the pinion shaft 3 where the pinion 7a is provided. The load bearing body 8 is held on a wall surface of a gear box 11. As the pinion shaft 3 is not restrained here in the axial direction, the pinion shaft 3 can move in the axial direction.

A wheel shaft 10 is arranged substantially in parallel to the pinion shaft 3. A wheel 7b meshing with the pinion 7a is arranged in the middle part of the wheel shaft 10. Wheel bearings 9a and 9b are fitted to the wheel shaft 10 on the two sides of the wheel 7b in the axial direction to rotatably support the wheel shaft 10. These wheel bearings 9a and 9b are also rolling bearings, supported by the gear box 11 on the outer ring side. A rotary encoder 12 is fitted to one end of the wheel shaft 10 to detect the angle of rotation of the wheel shaft 10. The rotary encoder 12 is fixed to the gear box 11 by an encoder keeper 13 one end of which is fixed to the gear box 11. The gear box 11, intended to house the pinion 7a and the wheel 7b, is box-shaped and connected to a motor housing 5a on the pinion shaft 3 side.

In the geared transmission apparatus 100 configured as described above, the pinion 7a and the wheel 7b are conical gears substantially equal in cone angle. The pinion shaft 3 and the wheel shaft 10 on which these gears 7a and 7b are disposed are arranged in parallel to each other. Part of the thrust with which the compression spring 15a presses the pinion shaft 3 in the axial direction is borne by the load bearing body 8 provided at an end of the pinion shaft 3. The end of the pinion shaft 3 coming into contact with the load bearing body 8 is formed in a convex spherical shape to prevent the pinion shaft 3 from being restrained in the radial direction.

In the middle part between the pinion 7a and the pinion bearing 4a in the axial direction, there is formed a portion 3x whose shaft diameter is smaller than the bore of the pinion bearing 4a and the larger-side outer diameter of the pinion 7a. As a result, when a force in a direction at a right angle to the shaft works on the pinion 7a, the pinion shaft 3 bends at the reduced-diameter portion 3x. When the load bearing body 8 and the pinion 7a are not in contact with each other, the thrust due to the compression spring 15a is wholly borne by the tooth surface of the pinion 7a. Since the position of the load bearing body 8 in the axial direction is adjustable, it is possible to have the thrust shared between the tooth surface of the pinion 7a and the load bearing body 8 by adjusting the position of the load bearing body 8 in the axial direction. The pinion shaft 3 is made of stainless steel of greater hardness, and resin of less hardness than the pinion shaft 3, such as polyacetal, is used as the material of the load bearing body 8.

The operations of this geared transmission apparatus 100 will be described below. When power supply to the driving motor 1 is turned on, the rotor core 2, the pinion shaft 3 and the pinion 7a formed integrally with the pinion shaft 3 rotate. When the pinion 7a rotates, the wheel 7b meshing with this pinion 7a also rotates, and motive power is transmitted to the wheel 7b. It has already been stated that, when the load bearing body 8 and the pinion 7a are not in contact with each other, the thrust due to the compression spring 15a is wholly borne by the tooth surface of the pinion. In this case, the tooth surfaces of the pinion 7a and the wheel 7b are in tight contact with each other on both the working flank and the non-working flank, resulting in complete absence of backlash. The reaction force then generating on the tooth surfaces is made greater than the thrust due to the compression spring 15a by a wedge effect. The wear of the tooth surfaces may be accelerated as a result. In view of this risk, the thrust working on the pinion shaft 3 is caused to be shared between the load bearing body 8 and the tooth surface of the pinion 7a by adjusting the position of the load bearing body 8 in the axial direction. The reaction force generating on the tooth surface of the pinion 7a can be thereby reduced.

As the working flank and the non-working flank of the pinion 7a then are kept in tight contact with each other by the reaction force, backlash can be reduced to virtual zero, and the rotation of the pinion 7a is accurately transmitted to the wheel 7b. Since the angle of rotation of the wheel shaft 10 is measured by the encoder 12, the wheel shaft 10 can be stopped accurately at any desired angle by using the measured angle of rotation for controlling the geared transmission apparatus.

Incidentally, fabrication of the gears 7a and 7b, their respective shafts 3 and 10, and the gear box 11 is subject to more or less errors. Or when forces work on these members to transmit motive power, they are elastically deformed by stresses. Furthermore, if the ambient temperature or some other condition varies, the members may be thermally deformed. Under any of these conditions, if the pair of the gears 7a and 7b in mesh with each other have no backlash, the parts of the geared transmission apparatus 100 will be operated under forced deformation. As a consequence, an internal force matching the spring constant of each part will arise as a reaction force. In a conventional geared transmission apparatus, as the gear side end of the pinion shaft is supported by the pinion shaft bearing, the spring constant in bending of the pinion shaft 3 is extremely high, and the internal force due to form errors also increases. As a result, gears and bearings are subject to early damages.

In this embodiment, one of the pinion bearings, 4a, is disposed between the pinion 7a and the rotor core 2 and the other, 4b, at the other end of the shaft than the pinion 7a to cantilever the pinion 7a. The spring constant in bending of the pinion shaft 3 is thereby reduced. As the reduced-diameter portion 3x is formed between the pinion 7a and the pinion bearing 4a, and the load bearing body 8 arranged at an end of the pinion shaft 3 is formed in a convex spherical shape to prevent the pinion 7a from being restrained in the radial direction, the spring constant in bending of the pinion shaft 3 is further reduced. As a result, the internal force due to form errors, including fabrication errors, is weakened to reduce loads on the pinion 7a and the bearings 4a and 4b. If the diameter of the pinion shaft 3 is varied in the axial direction, the spring constant of the pinion shaft 3 can be controlled. If the spring constant of the pinion shaft 3 in the bending direction is set smaller than the spring constant of the bearings 4a and 4b in the radial direction under that control, the internal force due to fabrication errors, assembling errors and deformation can be reduced.

When the geared transmission apparatus 100 is used for a long period, the tooth surfaces will wear out, and load conditions and other factors will become different from their initial states. These possible variations in operating conditions should also be taken into consideration in fabricating the geared transmission apparatus 100. FIG. 4A to FIG. 4D show variations in the operating conditions of the geared transmission apparatus 100 of this embodiment according to the invention after being operated for a long period. Area A is where the load bearing body 8 mainly supports the thrust, while Area B is where the tooth surface of the pinion 7a mainly supports the thrust.

In the initial state, the operation takes place in Area A. In Area A, the load on the tooth surface attributable to the thrust working on the pinion shaft 3 is small, and the load bearing body 8 bears a large share of the load. Since the hardness of the pinion 7a is greater than that of the load bearing body 8, the load bearing body 8 wears earlier than the tooth surface. As a result, the load shared by the load bearing body 8 decreases and that borne by the tooth surface of the pinion 7a increases. If the operation is continued, the decrease in its share of load will prevent the load bearing body 8 from wearing any further. On the other hand, there will be a shift to Area B wherein the tooth surface of the pinion 7a, whose share of load has increased, will begin to wear. Although the wear of the tooth surface tends to invite an increase in backlash, as the pinion 7a is pressed by the compression spring 15a, the pinion 7a will gradually shift in the axial direction along with the wear of the tooth surface. The state of tight contact between the working flank and the non-working flank will be maintained then. When the tooth surface has worn to a prescribed extent, the load shared by the load bearing body 8 will again increase, resulting in a shift to Area A. This cycle is repeated, and the backlash will remain small for a long period.

A geared transmission apparatus 100, which is another preferred embodiment according to the invention, will now be described with reference to FIG. 2. FIG. 2 shows a vertical section of this geared transmission apparatus 100. This embodiment differs from the foregoing embodiment in the positions of a compression spring 15b providing a thrust and of a load bearing body 8b. Thus, the compression spring 15b is arranged between the pinion 7a and the rotor core 2 and closer to the pinion 7a than the pinion bearing 4a. The compression spring 15b is held by a motor casing 5c arranged between the gear box 11 and the stator core 6. The compression spring 15b gives a thrust to the outer ring of the pinion bearing 4a.

On the other hand, the load bearing body 8b is held on the internal diameter side of a motor casing 5b and adjoining the pinion bearing 4b. The load bearing body supports most part of the thrust due to the force of the compression spring 15b working on the outer ring of the pinion bearing 4b. There are provided, for instance on the outer circumferential part of the load bearing body 8b and on the inner wall of the motor housing 5b, position adjusting means working in rotational directions like mutually fitting screws.

Since the pinion 7a is not restrained in the axial direction, the position of the load bearing body 8b in the axial direction is adjusted by turning the screws. Following this, the position of the pinion 7a in the axial direction also varies. To add, the gear box 11 for accommodating the pinion 7a and the wheel 7b and the motor casings 5b and 5c for holding the stator core 6 between them are separately formed. An elastic member 14 made of a rubber or plastic sheet intervenes in the connecting part between the gear box 11 and the motor casing 5c. In other respects, this embodiment is similar in configuration to the foregoing.

In this embodiment configured as described above, when power supply to the driving motor 1 is turned on, the rotor core 2 rotates, and motive power is transmitted from the pinion 7a to the wheel 7b. By adjusting the position of the load bearing body 8b, backlash can be kept to the practicable minimum, and the rotation of the pinion 7a can be accurately transmitted to the wheel 7b. Furthermore, as the motor casing 5c and the gear box 11 are coupled by way of the elastic member 14, even if a load works within the pinion 7a in a direction at a right angle to the shaft, the motor casing 5c and the gear box 11 can be displaced relative to each other, making it possible to release the internal force generated by the load in the direction at a right angle to the shaft. By keeping then Young's modulus of the elastic member 14 smaller than that of the pinion shaft 3, the deformation can be further facilitated. As a result, the loads on the pinion 7a and the bearings 4a and 4b are reduced, putting off the need to replace the pinion 7a or the bearings 4a and 4b for a long period.

If the geared transmission apparatus of this embodiment is used for a long period, the tooth surfaces of the pinion and the wheel will naturally wear and backlash will increase, but backlash can still be kept relatively small by adjusting the position of the load bearing body disposed close to the end of the shaft on the other side than the pinion. Therefore, the geared transmission apparatus of this embodiment allows extremely easy adjustment of backlash by the user even if it is used in a situation different from the operating pattern supposed at the time of designing. In other words, it can be flexibly adapted to the requirements of diverse operating patterns, differing from one customer to another.

According to the invention, since geared transmission apparatuses are configured as stated in the appended claims, the tooth surfaces of the two gears can be kept in tight contact with each other, and backlash can be kept to the practicable minimum. Highly accurate positioning can be made possible as a result. Moreover, since part of the thrust in the axial direction is borne by the load bearing body, the reaction force generating on the tooth surface matching the thrust is reduced, enabling gears and bearings to be used continually for a long period.

The preferred embodiments described herein are therefore illustrative and not restrictive, the scope of the invention being indicated by the appended claims and all variations which come within the meaning of the claims are intended to be embraced therein.

1. Geared transmission apparatus having a conical pinion disposed on a first rotation shaft and a conical wheel fitted to a second rotation shaft substantially parallel to this first rotation shaft and meshing with said conical pinion, said pinion and wheel being formed to have substantially equal cone angles, wherein said geared transmission apparatus further comprises supporting means for supporting said first rotation shaft to be movable in the axial direction, pressing means for applying thrust to this first rotation shaft in the axial direction, and a load bearing body, provided at an end of the first rotation shaft, for bearing the thrust applied by said pressing means and allowing the first rotation shaft to be displaced in the radial direction.

2. The geared transmission apparatus according to claim 1, further comprising means for making controllable a position of said load bearing body in the axial direction.

3. The geared transmission apparatus according to claim 1, wherein part of the thrust applied by said pressing means is guided to the tooth surfaces of said pinion and wheel.

4. The geared transmission apparatus according to claim 2, wherein part of the thrust applied by said pressing means is guided to the tooth surfaces of said pinion and wheel.

5. The geared transmission apparatus according to claim 1, wherein said load bearing body is arranged in a position in which it comes into contact with said first rotation shaft and hardness of this load bearing body is less than that of said first rotation shaft.

6. The geared transmission apparatus according to claim 5, wherein a region in which said first rotation shaft comes into contact with said load bearing body is formed in a convex spherical shape.

7. The geared transmission apparatus according to claim 1, wherein said supporting means is a rolling bearing and said load bearing body is kept in contact with an outer ring of the rolling bearing.

8. The geared transmission apparatus according to claim 7, further comprising means for making said load bearing body controllable in the axial direction.

9. The geared transmission apparatus according to claim 1, further comprising a first bearing housing for holding said supporting means, another supporting means for supporting said second rotation shaft, and a second bearing housing for holding this latter supporting means, wherein said first bearing housing and second bearing housing are kept in contact with each other via an intervening elastic member.

10. The geared transmission apparatus according to claim 2, further comprising a first bearing housing for holding said supporting means, another supporting means for supporting said second rotation shaft, and a second bearing housing for holding this latter supporting means, wherein said first bearing housing and second bearing housing are kept in contact with each other via an intervening elastic member.

11. The geared transmission apparatus according to claim 5, further comprising a first bearing housing for holding said supporting means, another supporting means for supporting said second rotation shaft, and a second bearing housing for holding this latter supporting means, wherein said first bearing housing and second bearing housing are kept in contact with each other via an intervening elastic member.

12. The geared transmission apparatus according to claim 1, wherein spring constant of said first rotation shaft in a bending direction is set smaller than that of said supporting means in the radial direction.

13. The geared transmission apparatus according to claim 9, wherein spring constant of said first rotation shaft in a bending direction is set smaller than that of said supporting means in the radial direction.

14. The geared transmission apparatus according to claim 10, wherein spring constant of said first rotation shaft in a bending direction is set smaller than that of said supporting means in the radial direction.

15. The geared transmission apparatus according to claim 11, wherein spring constant of said first rotation shaft in a bending direction is set smaller than that of said supporting means in the radial direction.

16. The geared transmission apparatus according to claim 12, wherein Young's modulus of said elastic member is smaller than that of said first rotation shaft.

17. The geared transmission apparatus according to claim 13, wherein Young's modulus of said elastic member is smaller than that of said first rotation shaft.

18. The geared transmission apparatus according to claim 14, wherein Young's modulus of said elastic member is smaller than that of said first rotation shaft.

19. The geared transmission apparatus according to claim 15, wherein Young's modulus of said elastic member is smaller than that of said first rotation shaft.
